(19) United States
(12) Patent Application Publication
(10) Pub. No.: US 2026/0241387 A1
(43) Pub. Date: Aug. 20, 2026

(54) Cleaning Cartridge for a Microfluidic Device, Microfluidic Device and Method for Cleaning the Microfluidic Device

(71) Applicant: Robert Bosch GmbH, Stuttgart (DE)

(72) Inventors: Armin Schuelke, Aidlingen (DE); Ronny Leonhardt, Gerlingen (DE)

(21) Appl. No.: 19/118,775

(22) PCT Filed: Sep. 29, 2023
(86) PCT No.: PCT/EP2023/077021

§ 371 Date: Apr. 6, 2025

(30) Foreign Application Priority Data
Oct. 11, 2022 (DE) 10 2022 210 704.7

(51) Int. Cl. B01L 3/00; B08B 1/10; B08B 1/30; B08B 1/40

(52) U.S. Cl. CPC B01L 13/00; B01L 3/502715; B08B 1/10; B08B 1/30; B08B 1/40; B01L 2200/146; B01L 2200/147; B01L 2300/021; B01L 2300/0663; B01L 2300/1805

(57) ABSTRACT

A cleaning cartridge for a microfluidic device includes at least one cleaning element. It also has at least one actuator that is set up to move the cleaning element. When cleaning the microfluidic device by way of the cleaning cartridge, the cleaning cartridge is inserted into a receiving area of the microfluidic device in such a way that at least one cleaning element is positioned on at least one element of the microfluidic device to be cleaned, and the cleaning element is then moved along the element to be cleaned by way of the actuator. Also disclosed is a microfluidic device which is set up to move at least one cleaning element of the cleaning cartridge along at least one element of the microfluidic device to be cleaned by way of at least one actuator of the cleaning cartridge.

The present invention relates to a cleaning cartridge for a microfluidic device. The present invention also relates to a method for cleaning the microfluidic device. Finally, the present invention relates to a microfluidic device adapted to be cleaned by means of the cleaning cartridge.

### PRIOR ART

Microfluidic analytical devices can be operated by inserting a cartridge containing a sample to be analyzed and chemicals that are reacted with the sample. Such cartridges are designed as disposable components and it is intended that all liquids remain in the cartridge and do not come into contact with the components of the other analytical devices. Nevertheless, a leak or damage to the cartridge can result in liquids escaping from the cartridge and contaminating components of the analytical device. The device can then usually only be cleaned by the manufacturer. Cleaning for maintenance purposes, for example to remove dust deposits, cannot be carried out by the user, but only by the manufacturer by dismantling the analytical device.

U.S. Pat. No. 10,828,675 B2 describes a cleaning cartridge by means of which components of a microfluidic analytical device can be cleaned. The cleaning cartridge has cleaning pads that must be soaked manually with a cleaning fluid by the user. The cleaning cartridge is then inserted into the analytical device. The analytical device must be set up in advance for cleaning using this cartridge. Components of the device to be cleaned are then guided along the cleaning pads in a cleaning program in order to clean them. Alternatively, the cleaning program can also provide for the entire cartridge to be moved in order to clean the components to be cleaned. An analytical device that is not set up for cleaning using this cleaning cartridge cannot be cleaned using it.

### DISCLOSURE OF THE INVENTION

The cleaning cartridge for a microfluidic device has at least one cleaning element. It also has at least one actuator which is set up to move the cleaning element relative to an element of the microfluidic device to be cleaned. It is therefore not necessary for a relative movement between a cleaning element and an element of the microfluidic device to be cleaned to occur through a movement of the element to be cleaned or through a movement of the entire cleaning cartridge. Rather, the cleaning element can be moved along the element to be cleaned by means of the actuator.

A microfluidic device designed as an analytical device usually has several elements to be cleaned. It is therefore preferable for the cleaning cartridge to have several cleaning elements. These are particularly preferably set up to be moved together by means of an actuator. Since the cleaning cartridge is provided to clean all elements to be cleaned in the analytical device by means of cleaning elements for which cleaning elements are actually present, a joint movement of all cleaning elements can be provided. As this joint movement is effected by a joint actuator, it is possible to design the cleaning cartridge in a simple way.

Furthermore, it is preferred that the cleaning cartridge has at least one cleaning element on a first side and at least one cleaning element on a second side opposite the first side. If a microfluidic analytical device is set up to receive a cartridge, such cartridge usually has a fluidic layer, a pneumatic layer and an elastomeric diaphragm arranged between the fluidic layer and the pneumatic layer. The fluidic layer is intended to transport a sample to be analyzed and other reagents, and to cause them to react with each other. The pneumatic layer is intended to apply positive pressure or negative pressure to the elastomeric diaphragm by means of pneumatic channels. By creating a positive pressure, the elastomeric diaphragm is deflected into the fluidic layer. By creating a negative pressure, the elastomeric diaphragm is deflected into the pneumatic layer. This allows fluid flows to be manipulated within the fluidic layer. In particular, the first side of the cleaning cartridge is intended to face a first side of a receiving area of the microfluidic device for receiving a cartridge. In particular, the second side of the cleaning cartridge is intended to face a second side of the receiving area. In particular, the first side of the receiving area may have a heating element that is provided to heat reagents in the fluidic layer of a cartridge. Furthermore, the first side of the receiving area may in particular have injection plungers which are provided to eject reagents from reagent bars in the fluidic layer into a fluid channel system of the fluidic layer. In particular, a pneumatic manifold is arranged on the second side of the receiving area, which is connected to a compressed air supply of the microfluidic device and is provided to build up a negative pressure or a positive pressure in pneumatic channels of the pneumatic layer of a cartridge. The pneumatic manifold turns its sealing mat towards the interior of the receiving area.

The cleaning elements are designed in particular as fleece belts, felt belts, brush belts or a combination of these. In particular, it may be provided that at least one cleaning element has different coating sections. In an embodiment, the belts can be designed as single belts running around rollers. In another embodiment, the belts can be designed to unroll, wherein the belt is unwound from one roller and simultaneously wound onto the other roller over the operating time in accordance with a cassette principle. A cleaning element, which is provided for cleaning a heater, preferably has a brush length in the range of 0.1 mm to 0.5 mm. A cleaning element, which is provided for cleaning an injection plunger assembly, also preferably has a brush length in the range of 0.1 mm to 0.5 mm. A cleaning element, which is provided for cleaning a sealing mat of a pneumatic manifold, preferably has a brush length in the range of 0.5 mm to 2.0 mm. This means that the brush length, which is understood to be the length of the felt hairs or brush hairs, is greater than the characteristic height of the elements to be cleaned, without being so long that free movement of the cleaning elements would be impaired.

In principle, it is possible that the cleaning elements must be wetted with a cleaning fluid by a user before using the cleaning cartridge. Preferably, however, at least one reservoir with a cleaning fluid is provided in the cleaning cartridge, which is fluidically connected to the cleaning element. If the cleaning element is designed as a belt, then it can be provided in particular that it is brought into contact with the cleaning fluid during each circulation. The cleaning fluid can be isopropanol or petroleum ether in particular.

If the cleaning cartridge is not designed as a disposable item, but is intended for multiple use, it is further preferred for it to have a collection container for contaminated cleaning fluid, which is fluidically connected to the cleaning element. In particular, the collection container has a scraper element to scrape off the contaminated cleaning fluid and dirt particles mixed with it into the collection container.

It is preferably provided that a reservoir of a reusable cleaning cartridge can be refilled and its collection container can be emptied in order to enable the cleaning cartridge to be used for a long time. The cartridge is also designed such that all functional elements can also be easily cleaned.

If the cleaning cartridge is designed as a disposable item and a cleaning fluid is to be dispensed with, the cleaning element is preferably designed such that dirt particles adhere to it. If only the reservoir for the cleaning fluid is to be dispensed with, the cleaning element can be soaked or wetted with cleaning fluid in particular.

The elements of a microfluidic device that face the fluidic layer of a cartridge are usually more exposed to contamination from fluids escaping from the cartridge than the pneumatic manifold. In addition, there are often more sensitive components on the first side of the receiving area of the microfluidic device than on the second side of the receiving area. If the cleaning cartridge has cleaning elements on both sides, it is therefore preferable that a reservoir with a cleaning fluid and a collection container for contaminated cleaning fluid are each connected only to a cleaning element on the first side of the cleaning cartridge, but not to a cleaning element on the second side of the cleaning cartridge. This design variant also prevents the transfer of particles to other functional elements of the microfluidic device.

In an embodiment of the cleaning cartridge, the actuator is electrically driven. The cleaning cartridge has at least one electrical energy store that is electrically connected to the actuator. This enables automated operation of the cleaning cartridge. If the cleaning cartridge is designed as a reusable item, an interface can also be provided to recharge the energy store.

If the actuator is electrically driven, it may alternatively or additionally be provided that the cleaning cartridge has at least one interface which is electrically connected to the actuator and which is arranged to be connected to an electrical power source of the microfluidic device. This means that there is no need for an electrical energy store in the cleaning cartridge. If an electrical energy store is nevertheless to be provided, it can be recharged by the electrical power source of the microfluidic device. The electrical connection between the interface and the actuator can then be made via the energy store. In particular, the interface can be a USB interface.

In a further embodiment of the cleaning cartridge, it is provided that the actuator is mechanically driven. For this purpose, the cleaning cartridge has at least one actuating element that is mechanically connected to the actuator. In this embodiment, the length of the cleaning cartridge is such that the actuating element remains accessible even when the cleaning cartridge is inserted into the microfluidic device. A user can then set the actuator in motion by actuating the actuating element, for example by a rotary or circular movement or a translatory or linear movement.

In principle, it is not required that the microfluidic device actively interacts with the cleaning cartridge. However, it is possible that functions of the microfluidic device, such as the creation of positive or negative pressure, are activated during the cleaning process in order to support the cleaning process. In principle, these functions could be started manually by a user. Preferably, however, the cleaning cartridge has an identification element that is set up to be read by the microfluidic device. Reading can take place when the cleaning cartridge is inserted into the microfluidic device or also before insertion by bringing the identification element into the vicinity of a sensor arranged on the outside of the microfluidic device. By reading the identification element, the microfluidic device recognizes that a cleaning cartridge has been inserted into it and that functions that support the cleaning process should be started. In an embodiment of the cleaning cartridge, the identification element is a QR code. In another embodiment of the cleaning cartridge, the identification element is an RFID transponder.

It is also preferred that the cleaning cartridge has at least one sensor. The sensor can be used to monitor cleaning success. It can also be used to check elements to be cleaned for defects. If the microfluidic device is set up to interact with the cleaning cartridge, it can also be provided that valves, switches or actuators in the receiving area of the microfluidic device are controlled and their functionality is checked by means of the sensor. The result of this diagnosis can then be output via an interface on the microfluidic device.

In particular, the sensor can be an optical sensor to enable diagnosis by means of imaging, a temperature sensor to check the performance of a heating element of the microfluidic device, a pressure sensor to check the function of the pneumatic manifold of the microfluidic device, or a force sensor to monitor contact pressures of individual components of the microfluidic device, such as a heating element or the pneumatic manifold, against the cleaning cartridge.

In the method for cleaning the microfluidic device by means of the cleaning cartridge, the cleaning cartridge is inserted into a receiving area of the microfluidic device in such a way that at least one cleaning element is positioned on at least one element of the microfluidic device to be cleaned. The cleaning element is then moved along the element to be cleaned by means of the actuator. In doing so, a change in the speed and/or direction of movement can be provided in particular. Steps of the method are implemented in particular as a computer program in the microfluidic device in order to trigger actions of the microfluidic device and/or to control the cleaning cartridge via an interface in such a way that actions are triggered in it.

It is preferred that a heating element and/or a compressed air supply of the microfluidic device is activated during the process. In particular, the heating element is controlled in such a way that a temperature is generated on its surface facing the cleaning cartridge that is above the ambient temperature in the receiving area, but no higher than 60° C. This makes it easier to loosen incrustations and deposits on the surface of the heating element without causing unwanted evaporation of a cleaning agent. The compressed air supply can be activated to blow out sealing points or to prevent dirt particles from being transported into the pneumatic manifold's control holes when cleaning a sealing mat.

It can also be provided that injection plungers of the microfluidic device are moved towards the cleaning cartridge to make it easier to clean.

If the cleaning cartridge has a sensor, the method preferably analyzes the microfluidic device in the manner described in connection with the sensor.

While the cleaning cartridge can in principle be used with a conventional microfluidic device, the microfluidic device is preferably set up to move at least one cleaning element of the cleaning cartridge along at least one element of the microfluidic device to be cleaned by means of an actuator of the cleaning cartridge. This can be done by controlling an electrically driven actuator via an interface between the cleaning cartridge and the microfluidic device.

In particular, the microfluidic device has an interface in its receiving area that is designed to be connected to an interface of the cleaning cartridge.

### BRIEF DESCRIPTION OF THE DRAWINGS

Exemplary embodiments of the invention are illustrated in the drawings and explained in more detail in the following description.

FIG. 1 schematically shows a first exemplary embodiment of a cleaning cartridge according to the invention.

FIG. 2 shows a sectional view of a microfluidic device in which the cleaning cartridge shown in FIG. 1 is inserted.

FIG. 3 shows a flow chart of a method according to an exemplary embodiment of the invention.

FIG. 4 schematically shows a cleaning cartridge according to a second exemplary embodiment of the invention.

FIG. 5 shows a sectional view of a microfluidic device into which a cleaning cartridge as shown in FIG. 4 is inserted.

FIG. 6 schematically shows a cleaning element of an exemplary embodiment of a cleaning cartridge according to the invention.

FIG. 7 schematically shows a cleaning element of another exemplary embodiment of a cleaning cartridge according to the invention.

FIG. 8 shows a side view of a belt of a cleaning element of a cleaning cartridge according to the invention.

### EXEMPLARY EMBODIMENTS OF THE INVENTION

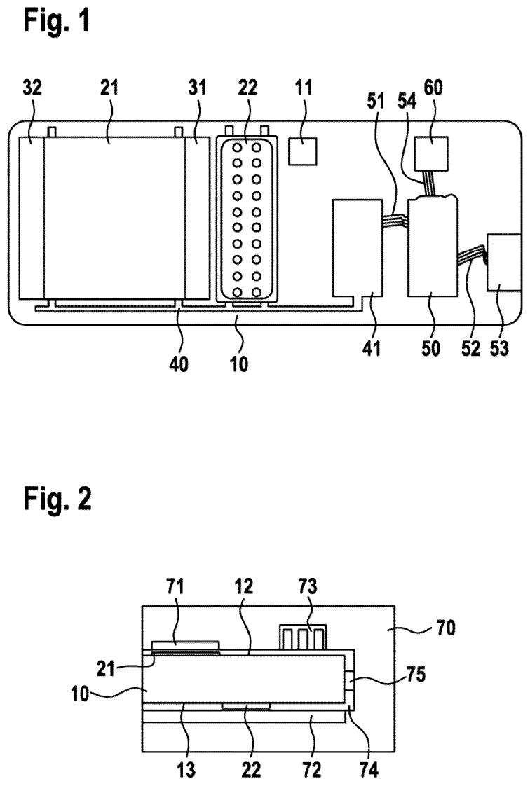

A cleaning cartridge 10 according to a first exemplary embodiment of the invention is shown in FIG. 1. It has an identification element 11 in the form of a QR code, by means of which it can be identified by a microfluidic device. A first cleaning element 21, which is arranged on a first side 12 of the cleaning cartridge 10 acting as the upper side, is designed as a felt belt with a hair length of 200 μm, for example. It has a reservoir 31 filled with isopropanol as a cleaning fluid. It also has a collection container 32 for contaminated cleaning fluid. A second cleaning element 22 is arranged on a second side 13 of the cleaning cartridge 10, which functions as the underside. It is designed as a brush belt with a brush length of 500 μm, for example. The two cleaning elements 21, 22 are driven jointly by an actuator 40. During the movement of the first cleaning element 21, cleaning fluid is transported from the reservoir 31 onto the first cleaning element 21 and then picked up again by the collection container 32. The actuator 40 is driven by an electric drive 41. This is supplied with electrical energy by an electrical energy store 50 in the form of a battery via a first electrical connection 51. A second electrical connection 52 connects the energy store 50 to an interface 53. A third electrical connection 54 connects the electrical energy store 50 to an optical sensor 60.

FIG. 2 shows a microfluidic device 70 that is to be cleaned with the cleaning cartridge 10. It has a heating element 71, a pneumatic manifold 72 and an injection plunger assembly 73. The heating element 71 and the injection plunger assembly 73 are arranged on an upper side of a receiving area of the microfluidic device 70. The pneumatic manifold 72 is arranged on its underside. The cleaning cartridge 10 is arranged in the receiving area 74 in such a way that its first side 12 faces upwards and its second side 13 faces downwards. As a result, the first cleaning element 21 comes into contact with the heating element 71 and the second cleaning element 22 comes into contact with the pneumatic manifold 72. The interface 53 connects to an interface 75 of the microfluidic device, which is electrically connected to its electrical power source (not shown).

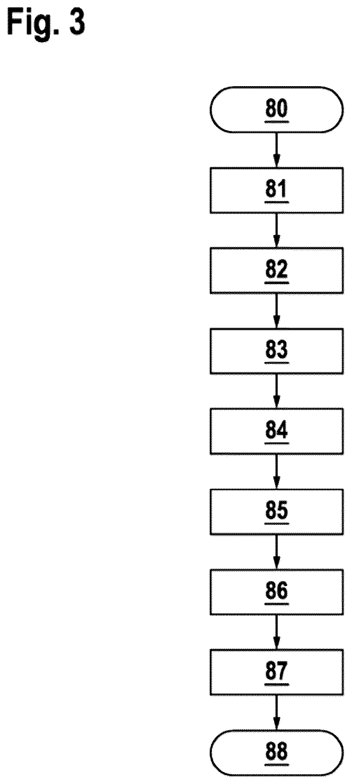

The cleaning sequence of the microfluidic device 70 is shown in FIG. 3. After a user decides to clean the microfluidic device 70 at the start 80 of the cleaning process, he first inserts the cleaning cartridge 10 into the receiving area 74 81. The microfluidic device now recognizes by reading the identification element 11 that the cleaning cartridge 10 has been inserted into it 82. The heating element 71 is then activated 83 by heating it to a temperature of 50° C., for example, and the pneumatic manifold 22 is activated by generating a positive pressure of 0.2 bar, for example, by means of its compressed air supply. After this activation 83 has been completed, a signal is sent to the cleaning cartridge 10 via the interfaces 53, 75 to activate the electric drive 41 of the actuator 40 and thus initiate the cleaning of the heating element 71 and the pneumatic manifold 72 84. After the sensor 60 has detected that cleaning is complete, the electric drive 41 is switched off 85. The sensor 60 is then used, for example, to optically analyze 86 the heating element 71 and the pneumatic manifold 72 for defects. The result of this analysis is output to a user interface of the microfluidic device 71. The cleaning cartridge 10 is then removed 87 from the receiving area 74 of the microfluidic device 70. This concludes the cleaning method 88.

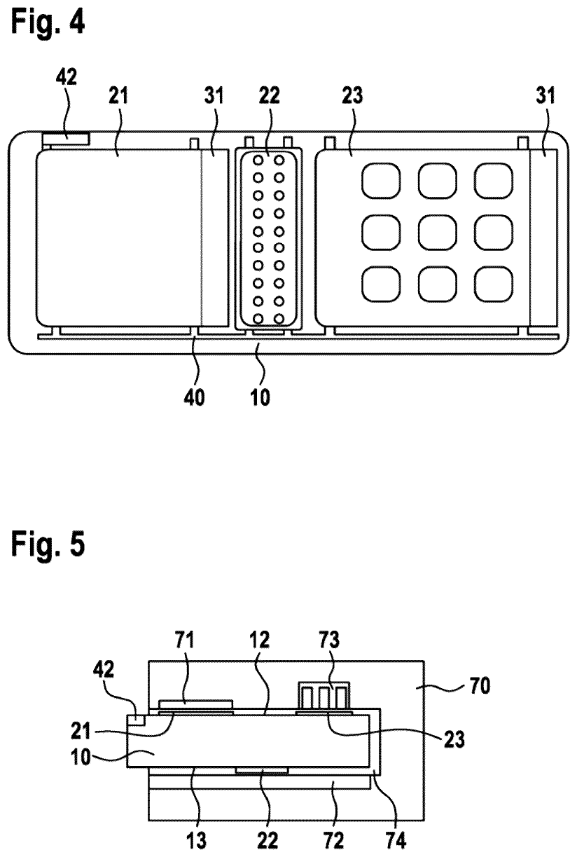

A second exemplary embodiment of the cleaning cartridge 10 is shown in FIG. 4. While the cleaning cartridge 10 according to the first exemplary embodiment is designed as a reusable cartridge which can interact with the microfluidic device 70 and whose actuator 40 is electrically driven, the cleaning cartridge 10 according to the second exemplary embodiment of the invention is a mechanically driven disposable cartridge. Compared to the first exemplary embodiment, the identification element 11, the electrical drive 41, the electrical energy store 50, the interface 53, the sensor 60 and all electrical connections 51, 52, 54 are dispensed with. To actuate the actuator 40, a mechanical actuating element 42 is provided, which in the present exemplary embodiment is designed as a drive wheel. The collection container 32 is also dispensed with, as the cleaning cartridge 10 is only provided for single use. The installation space gained in this way is used to provide a third cleaning element 23 on the top of the cleaning cartridge 10. Just like the first cleaning element 21, this has a reservoir 31 with isopropanol as the cleaning fluid.

When the cleaning cartridge according to the second exemplary embodiment of the invention, as shown in FIG. 5, is inserted into the microfluidic device 10, it protrudes slightly from the receiving area 74 of the microfluidic device 70, unlike the cleaning cartridge 10 according to the first exemplary embodiment of the invention. This makes the mechanical actuating element 41 accessible from the outside. The first cleaning element 21 and the second cleaning element 22 come to rest on the heating element 71 and on the pneumatic manifold 72 of the microfluidic device 70 in the same way as in the cleaning cartridge according to the first exemplary embodiment of the invention. The third cleaning element 23 is positioned on the injection plunger assembly 73. When a user now turns the actuating element 41, he sets the three cleaning elements 21, 22, 23 in motion by means of the actuator 40 such that they clean the heating element 71, the pneumatic manifold 72 and the injection plunger assembly 73 of the microfluidic device 70. The first cleaning element 21 and the third cleaning element 23 are wetted with cleaning fluid. Once cleaning is complete, the cleaning cartridge 10 is removed from the receiving area 74 of the microfluidic device 70 and then disposed of.

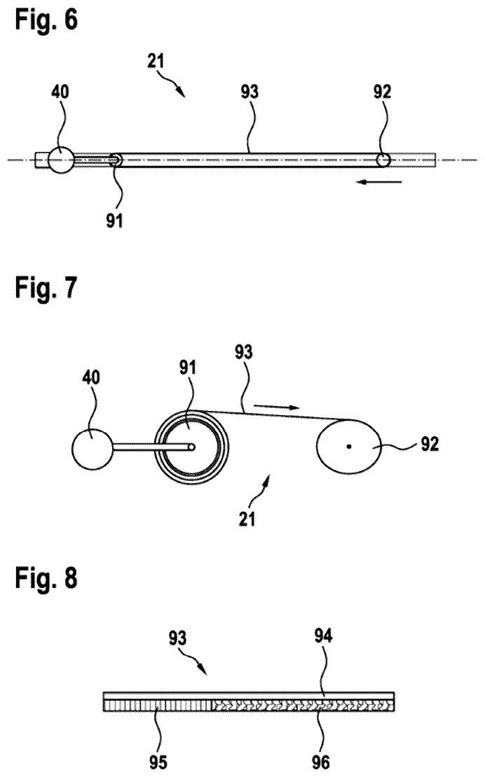

In both exemplary embodiments of the invention, the first cleaning element 21 can be designed as a binding. This is shown in FIG. 6. A belt 93 runs in the direction of the arrow around a first roller 91 and a second roller 92. The first roller 91 is driven by the actuator 40.

Alternatively, in both exemplary embodiments of the invention, the first cleaning element 21 can be designed in the manner shown in FIG. 7. The belt 93 is unwound from a first roller 91 in the direction of the arrow and wound onto a second roller 92. The first roller 91 is driven by the actuator 40.

In a further exemplary embodiment, the belt 93 has a carrier 94 on which a brush section 95 and a non-woven section 96 are arranged alternately. This is shown in FIG. 8.

1. A cleaning cartridge for a microfluidic device, comprising:
at least one cleaning element; and
at least one actuator which is arranged and configured to move the at least one cleaning element

2. The cleaning cartridge according to claim 1, wherein the at least one cleaning element is designed as a fleece belt, felt belt, brush belt or a combination thereof.

3. The cleaning cartridge according to claim 1, wherein the at least one cleaning element includes a plurality of cleaning elements which are arranged to be moved jointly by way of the at least one actuator.

4. The cleaning cartridge according to claim 1, wherein:
the cleaning cartridge defines (i) a first side, and (ii) a second side opposite the first side,
the at least one cleaning element includes a first cleaning element on the first side, and
the at least one cleaning element further includes a second cleaning element on the second side.

5. The cleaning cartridge according to claim 1, further comprising:
at least one storage container; and
a cleaning fluid stored in the at least one storage container,
wherein the at least one storage container is fluidically connected to the at least one cleaning element

6. The cleaning cartridge according to claim 5, further comprising at least one collection container, wherein:
the at least one collection container is configured to contain contaminated cleaning fluid, and
the at least one collection container is fluidically connected to the at least one cleaning element.

7. The cleaning cartridge according to claim 1, further comprising at least one electrical energy store, wherein:
the at least one actuator is electrically driven, and
the at least one electrical energy store is electrically connected to the at least one actuator.

8. The cleaning cartridge according to claim 1, further comprising at least one interface, wherein:
the at least one actuator is electrically driven,
the at least one interface is electrically connected to the at least one actuator and
the at least one interface is configured to be connected to an electrical power source of the microfluidic device.

9. The cleaning cartridge according to claim 1, further comprising at least one actuating element, wherein:
the at least one actuator is mechanically driven, and
the at least one actuating element is mechanically connected to the at least one actuator.

10. The cleaning cartridge according to claim 1, further comprising an identification element configured to be read out by the microfluidic device.

11. The cleaning cartridge according to claim 1, further comprising at least one sensor.

12. A method for cleaning a microfluidic device by way of a cleaning cartridge according to claim 1, comprising:
introducing the cleaning cartridge into a receiving area of the microfluidic device in such a way that the at least one cleaning element is positioned on the at least one element of the microfluidic device to be cleaned, and
subsequently moving the at least one cleaning element along the at least one element to be cleaned by way of the at least one actuator.

13. The method according to claim 12, further comprising activating a heating element and/or a compressed air supply of the microfluidic device.

14. The method according to claim 12, further comprising carrying out an analysis of the microfluidic device by way of a sensor.

15. A microfluidic device configured to move at least one cleaning element of a cleaning cartridge according to claim 1 along at least one element of the microfluidic device to be cleaned by way of at least one actuator of the cleaning cartridge.
